(19) United States
(12) Patent Application Publication
(10) Pub. No.: US 2008/0004873 A1
(43) Pub. Date: Jan. 3, 2008

(54) Perceptual coding of audio signals by spectrum uncertainty

(76) Inventors: Chi-min Liu, Hsinchu City (TW); Wen-chieh Lee, Taoyuan City (TW); Chiou Tin, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/475,951

(22) Filed: Jun. 28, 2006

(51) Int. Cl. G10L 19/02

(52) U.S. Cl. 704/229

(57) ABSTRACT

A method for digital encoding of an audio stream in which the psychoacoustic modeling bases its computations upon an MDCT for the intensity and a spectral flatness measurement that replaces the phase data for the unpredictability measurement. This dramatically reduces computational overhead while also providing an improvement in objectively measured quality of the encoder output. This also allows for determination of tonal attacks to compute masking effects.

### BACKGROUND OF INVENTION

1. Field of the Invention

This invention relates to a method of encoding audio signals, and more specifically, to an efficient method of encoding audio signals into digital form that significantly reduces computational requirements.

2. Description of the Prior Art

The digital audio revolution created by the compact disc (CD) has made further advances in recent years thanks to the advent of audio compression technology. Audio compression technology has evolved from straightforward lossless data compression, through math-oriented lossy compression focused solely on data size, to the quality-oriented lossy psychoacoustic models of today where audio samples are analyzed for what parts of the sound the human ear can actually hear. Lossy quality-oriented compression allows audio data to be compressed to perhaps 10% of its original size with minimal loss of quality, compared to lossless compression's typical best-case compression of 50%, albeit with no loss of quality.

Please refer to FIG. 1, which is a modular chart showing an encoder using the method of the prior art. A time-domain quantized signal TS is input to an AAC Gain Control Tool 100. The gain-controlled signal is passed to a Window Length Decision 110 module as well as to the Filterbank 120. In the Window Length Decision 110 module, the signal is analyzed for tonal attack, global energy ratio, and zero-crossing ratio, and an appropriate windowing strategy is passed to the Filterbank 120. The Filterbank 120 takes the windowing strategy and the gain-controlled signal, convolves the signal into a frequency-domain data set using a Modified Discrete Cosine Transform (MDCT), and passes the frequency-domain data set to both the Psychoacoustic Model 140 and the Spectral Normalization 130 module. The Psychoacoustic Model 140 also gets the time-domain quantized signal TS, and again convolves the signal TS into another frequency-domain data set using a Fast Fourier Transform (FFT) on the time-domain data, and uses the output of the FFT to calculate masking effects and builds a set of signal-to-masking ratios. These are passed to the TNS 150 module, the Intensity/Coupling 160 module, and the M/S 180 module. The Intensity/Coupling 160 module's processing is omitted for brevity; it passes its output to the M/S 180 module, which performs a computation (omitted for brevity) and passes its output to the AAC Quantization and Coding 190 module.

The AAC Gain Control Tool 100, Filterbank 120, Spectral Normalization 130, TNS 150, Intensity/Coupling 160, Prediction 170, M/S 180, and AAC Quantization and Coding 190 modules all pass data to the Bitstream Formatter 1BF, which produces the final output.

Psychoacoustic principles include absolute threshold of hearing (ATH), critical band analysis, masking effects, and perceptual entropy. For example, the absolute threshold of hearing can be approximated, for a trained listener with acute hearing, by the following function:

$$\begin{matrix}{T}_{q} ( f ) = 3.64 \times {( \frac{f}{1000} )}^{- 0.8} - 6.5 {{e}^{- 0.6} ( \frac{f}{1000} - 3.3 )}^{2} + \\ {10}^{- 3} {( \frac{f}{1000} )}^{4} ( dbSPL )\end{matrix} \qquad ( eq 1 )$$

T_{q}(f) can be thought of as the maximum allowable energy level for coding distortion. However, there are further aspects to audio encoding distortion, and so the ATH function is used conservatively to estimate masking levels.

Critical band analysis is a second aspect of psychoacoustic modeling. This attempts to model how the sound receptors along the basilar membrane in the cochlea of the human ear respond to sounds. The bands are defined in units called “barks”, from the following formula:

$$z ( f ) = 13 arc tan ( 0.00076 f ) + 3.5 arc tan [ {( \frac{f}{7500} )}^{2} ] Bark \qquad ( eq 2 )$$

### The critical bandwidth can be calculated by the following formula as derived by Zwicker:

$${BW}_{c} ( f ) = 25 + {75 [ 1 + 1.4 {( \frac{f}{1000} )}^{2} ]}^{0.69} Hz \qquad ( eq 3 )$$

This results in 25 critical bands:

TABLE 1
Critical Bands and Bandwidths

| Band | Center | Bandwidth |
|---|---|---|
| No. | Freq. | (Hz) |
| 1 | 50 | 0–100 |
| 2 | 150 | 100–200 |
| 3 | 250 | 200–300 |
| 4 | 350 | 300–400 |
| 5 | 455 | 400–510 |
| 6 | 570 | 510–630 |
| 7 | 700 | 630–770 |
| 8 | 845 | 770–920 |
| 9 | 1000 | 920–1080 |
| 10 | 1175 | 1080–1270 |
| 11 | 1375 | 1270–1480 |
| 12 | 1600 | 1480–1720 |
| 13 | 1860 | 1720–2000 |
| 14 | 2160 | 2000–2320 |
| 15 | 2510 | 2320–2700 |
| 16 | 2925 | 2700–3150 |
| 17 | 3425 | 3150–3700 |
| 18 | 4050 | 3700–4400 |
| 19 | 4850 | 4400–5300 |
| 20 | 5850 | 5300–6400 |
| 21 | 7050 | 6400–7700 |
| 22 | 8600 | 7700–9500 |
| 23 | 10750 | 9500–12000 |
| 24 | 13750 | 12000–15500 |
| 25 | 19500 | 15500+ |

Masking is a third aspect of psychoacoustic modeling. There are several types of masking, which can be classified from a time perspective as either simultaneous masking or nonsimultaneous masking.

Finally, an important part of psychoacoustic modeling is the notion of perceptual entropy. The typical way to calculate perceptual entropy is to take a Hanning window of the input time-domain signal, perform a 2048-point Fast Fourier Transform (FFT) on the signal to convolve it into a frequency-domain data set, perform critical-band analysis with spreading, use an uncertainty measurement to determine the tonality of the signal, and calculate masking thresholds by applying threshold rules and the ATH to the signal.

A Hanning window is calculated by the following function:

$$sw ( i ) = s ( i ) \times ( 0.5 - 0.5 cos ( \frac{π ( i + 0.5 )}{1024} ) ) \qquad ( eq 4 )$$

Combining the above into the standard Psychoacoustic Model II (PMII), the following steps occur:
Step 1: Input the sample stream. Two window lengths are used, a long window of 2048 samples and a short window of 128 samples.
Step 2: Calculate the complex spectrum of the input signal. For the length of the sample, use equation 4 (eq 4) above to generate a windowed signal, and then perform a FFT on sw(i) to generate the amplitudes and phases of the signal across the spectrum at a set of spectral lines, represented in polar coordinates. The polar coordinates are stored in r(w) for the magnitude, and f(w) for the phase.
Step 3: Estimate predicted values of r(w) and f(w), r_pred(w) and f_pred(w) from the two preceding frames and the current frame.

r_{—}pred(w)=2.0r(t−1)−r(t−2), and

f_{—}pred(w)=2.0f(t−1)−f(t−2) (eq 5)

where t represents the current block number, t-1 represents the previous block number, and t-2 represents the second-previous block number. This uses the median to predict the next value magnitude and phase:

$$\begin{matrix}current ( w ) = \frac{next ( w ) + last ( w )}{2} ⇒ next ( w ) \\ = 2 \times current ( w ) - last ( w )\end{matrix} \qquad ( eq 6 )$$

Step 4: Calculate the unpredictability measurement (UM) of the signal, c(w).

$$tmp\_cos = {( r ( w ) cos ( f ( w ) ) - r\_pred ( w ) cos ( f\_pred ( w ) ) )}^{2} \\ tmp\_sin = {( r ( w ) sin ( f ( w ) ) - r\_pred ( w ) sin ( f\_pred ( w ) ) )}^{2} \\ c ( w ) = \frac{\sqrt{tmp\_cos + tmp\_sin}}{r ( w ) + abs ( r\_pred ( w ) )} \qquad ( eq 7 )$$

### This takes the difference between the real and predicted spectral lines, and divides the difference by r(w)+abs(r_pred(w)) to normalize the UM to the range [0.1].

Step 5: Calculate the energy and unpredictability in the threshold calculation partition band. The energy in each partition e(b) is given by the following equation:

$$e ( b ) = {\sum }_{lower {index}_{b}}^{upper {index}_{b}} {r ( w )}^{2} \qquad ( eq 8 )$$

And the weighted unpredictability c(b) is:

$$e ( b ) = {{\sum }_{lower {index}_{b}}}^{upper {index}_{b}} {r ( w )}^{2} c ( w ) \qquad ( eq 8 )$$

### The upper index is the highest frequency line in the partition band, and the lower index is the lowest line in the partition band.

Step 6: Convolve the partitioned energy and unpredictability measurement with a spreading function, and normalize the result.

$$\begin{matrix}ecb ( b ) = {\sum }_{for each partition band} e ( bb ) spreading ( bval ( bb ) , bval ( b ) ) & ( eq 9 ) \\ ct ( b ) = {\sum }_{for each partition band} c ( bb ) spreading ( bval ( bb ) , bval ( b ) ) & ( eq 10 )\end{matrix}$$

The spreading function is calculated as follows:

$$Input = spreading ( i , j )$$

$$if j \geq i$$

$$tmpx = 3.0 ( j - i )$$

$$else$$

$$tmpx = 1.5 ( j - i )$$

$$tmpz = 8 * min ( {( tmpx - 0.5 )}^{2} - 2 ( tmpx - 0.5 ) , 0 )$$

$$tmpy = 15.811389 + 7.5 ( tmp + 0.474 ) - 17.5 {( 1.0 + {( tmpx + 0.474 )}^{2} )}^{\frac{1}{2}}$$

$$if ( tmpy < - 100 )$$

$$spreading ( i , j ) = 0$$

$$else$$

$$spreading ( i , j ) = {10}^{\frac{( TMPZ + TMPY )}{10}}$$

where i is the Bark value of the signal being spread, and j is the Bark value of the band being spread into.

bval(b) means the median bark of the partition band b.

Because ct(b) is weighted by the signal energy, it must be renormalized to cb(b) as

$$cb ( b ) = \frac{ct ( b )}{ecb ( b )} \qquad ( eq 11 )$$

Similarly, due to the non-normalized nature of the spreading function, ecb_{b} should be renormalized and then normalized energy en_{b} is obtained:

en(b)=ecb(b)×rnorm(b). (eq 12)

The normalization coefficient rnorm(b) is:

$$tmp ( b ) = {\sum }_{for each partition band} spreading ( bval ( bb ) , bval ( b ) ) \\ rnorm ( b ) = \frac{1}{tmp ( b )} \qquad ( eq 13 )$$

Step 7: Convert cb(b) to a tonality index in the range [0.1] as follows:

tb(b)=−0.299−0.43 logₑ(cb(b)) (eq 14)
Step 8: Calculate the required SNR in each partition band.

The noise-masking-tone level in decibels, NMT(b) is 6 dB for all bands b.

The tone-masking-noise level in decibels, TMN(b) is 18 dB for all bands b.

The required signal-to-noise ratio in each band, SNR(b) is:

SNR(b)=tb(b)×TMN(b)+(1−tb(b))×NMT(b) (eq 15)
Step 9: Calculate the power ratio, bc(b), by the following equation:

$$bc ( b ) = {10}^{\frac{- SNR}{10}} \qquad ( eq 16 )$$

Step 10: Calculate the actual energy threshold nb(b) by the following equation:

nb(b)=en(b)×bc(b) (eq 17)
Step 11: Controlling pre-echo and threshold in quiet periods. The pre-echo control is calculated for short and long FFT, with consideration for the threshold in quiet:

nb_l(b) is the threshold of partition b for the last block, and qsthr(b) is the threshold in quiet. rpelev is set to 0 for short blocks and 2 for long blocks. The dB value must be converted into the energy domain after considering the FFT normalization used.

nb(b)=max(qsthr(b), min(nb(b), nb_{—}l(b)×rpelev)) (eq 18)
Step 12: Calculate perceptual entropy for each block type from the ratio e(b)/nb(b), where nb(b) is the energy threshold from Step 10 and e(b) is the energy from Step 5, with bandwidth(b) being the width of the critical band from Table 1, using the following formula:

$$PE = {\sum }_{for each partition band} - {log}_{10} ( \frac{nb ( b )}{e ( b ) + 1} ) \times Bandwidth ( b ) \qquad ( eq 19 )$$

Step 13: Choose whether to use a short or long block type, or a transition block type. The following pseudocode explains the decision, with switch_pe being an embodiment-defined constant:

```
  if (long_block_PE > switch_pe) then
    block_type = SHORT ;
  else
    block_type = LONG ;
  endif
  if ((block_type == SHORT) AND (previous_block_type == LONG))
then
    previous_block_type = START_SHORT ;
  else
    previous_block_type = SHORT ;
  endif
```

Note that the second condition statement can change the type of the previous block to create a transition block from long blocks to short blocks.
Step 14: Calculate the signal-to-masking ratios SMR(n).

The output of the psychoacoustic model is a set of Signal-to-Masking ratios, a set of delayed time domain data used by the filterbank, and an estimation of how many bits should be used for encoding in addition to the average available bits.

The index swb of the coder partition is called the scalefactor band, and is the quantization unit. The offset of each MDCT spectral line for the scalefactor band is swb_offset_long/short_window

Given the following formulas:

n=swb

w_low(n)=swb_offset_long/short_window(n)

w_high(n)=swb_offset_long/short_window(n+1)−1

The FFT energy in the scalefactor band epart(n) is:

$$epart ( n ) = {\sum }_{for each scalefactor band} {r ( w )}^{2} \qquad ( eq 20 )$$

and the threshold for one line of the spectrum in the partition band is calculated according to the formula:

$$thr ( w\_low ( b ) , … , w\_high ( b ) ) = \frac{nb ( b )}{w ( high ( b ) - low ( b ) + 1 )} \qquad ( eq 21 )$$

the noise level in the scalefactor band on FFT level npart(n) is calculated by:

npart(n)=min(thr(w_low(n)) . . . , thr(w_high(n)))*(w_high(n)−w_low(n)+1) (eq 22)

And, finally, the signal-to-masking ratios are calculated with the formula:

$$SMR ( n ) = \frac{epart ( n )}{npart ( n )} \qquad ( eq 23 )$$

Please refer to FIG. 2, a flowchart of the above method. The time-domain data of step 1 is input at block 200. The FFT of step 2 is performed at block 210. The UM of steps 3 and 4 are performed in block 220. The threshold calculation of step 5 is performed in block 230. The PE (perceptual entropy) calculations of steps 6 through 12 are performed in block 240. Blocks 250, 260a, 260b, and 270 perform step 14; block 250 chooses whether to use the long block or short block threshold calculation of step 13, and in either case block 270 makes the final window decision choice and calculates the SMRs of step 14. Block 280 lists the outputs of the calculation.

Calculating the SMRs entails in part calculating an energy floor to detect deviation of signal strength. The prior art uses a variety of methods for this, including a recursive filter via the following equations:

$$\begin{matrix}{\hat{x}}_{i} = α \times {\hat{x}}_{i - 1} + ( 1 - α ) \times {x}_{i} & ( eq 24 a ) \\ {Energyfloor}_{b} = \frac{1}{{Bandwidth}_{b}} \times {\sum }_{for each partition band} {\hat{x}}_{i} & ( eq 24 b )\end{matrix}$$

and a geometric mean filter:

$${Energyfloor}_{b} = \sqrt[\frac{1}{{Bandwidth}_{b}}]{{\prod }_{i = 0}^{N - 1} {x}_{i}} \qquad ( eq 25 )$$

There are several problems inherent in current methods. The computational needs for encoding are quite high, requiring expensive processors which use large amounts of power. Different, inconsistent spectra are from the FFT and MDCT are respectively used for analysis and for encoding, resulting in sound distortion and additional computational requirements. The noise masking effect is stronger than the tone masking effect, but the energy is dominated by the tone, resulting in an overestimation of masking. Also, the standard psychoacoustic model only detects attacks in the time domain, not in the frequency domain. For energy floor estimation, the geometric-mean filter degrades strong peak signals, while the recursive filter tends to distort and shift the energy floor.

### SUMMARY OF INVENTION

It is therefore necessary to create an improved method for psychoacoustic encoding of audio data. A primary objective of this invention is to use the same spectrum for both analysis and encoding of the signal. Another objective of this invention is to detect attacks in both the time and frequency domains. Another objective of this invention is to reduce computational overhead, thereby allowing cheaper, slower processors with lower power consumption to be used for encoding audio data. Another objective is to more accurately measure masking effects, resulting in improved encoded audio quality.

In order to achieve these objectives, an improved method for encoding audio data comprises the following steps: using a filterbank with an modified discrete cosine transformation (MDCT) to create an MDCT dataset, using a spectral flatness measure in a perceptual model to compute an uncertainty measure; and using the uncertainty measure and MDCT dataset in the perceptual model to generate a set of signal-to-masking ratios.

In order to further achieve these objectives, a method for encoding a discretely represented time-domain signal, said signal represented by a series of coefficients, comprises the following steps: selecting a subset of the series of coefficients according to a windowing method; transforming the subset into a frequency-domain data set of coefficients at a plurality of spectral lines using a modified discrete cosine transformation (MDCT); using the frequency-domain data set to generate a set of signal-to-masking ratios, a set of delayed time-domain data, and a set of bit-allocation limits; and generating a set of values from the set of signal-to-masking ratios, the set of bit-allocation limits, and the frequency-domain data set.

In order to further achieve these objectives, a method for encoding a discretely represented time-domain signal, said signal represented by a series of coefficients, comprises the following steps: selecting a subset of the series of coefficients according to a windowing method; transforming the subset into a frequency-domain data set of coefficients at a plurality of spectral lines using a modified discrete cosine transform (MDCT); dividing the frequency-domain data set according to a plurality of critical bands; and for each critical band: determining a first endpoint and a second endpoint of a critical band; generating a band sum by summing smoothing values of the coefficients at a plurality of spectral lines between the first endpoint and the second endpoint of the critical band; and calculating an energy floor for the critical band by dividing the band sum by a bandwidth of the critical band.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a modular chart showing a prior-art encoder.

FIG. 2 is a flow chart showing a prior-art perceptual module.

FIG. 3 is a modular chart showing an encoder using the method of the present invention.

FIG. 4 is a flow chart showing a perceptual module of the present invention.

FIG. 5 is a graph showing an example frequency-domain data set of a prior-art encoder.

FIG. 6 is a graph showing an example frequency-domain data set of an encoder using the method of the present invention.

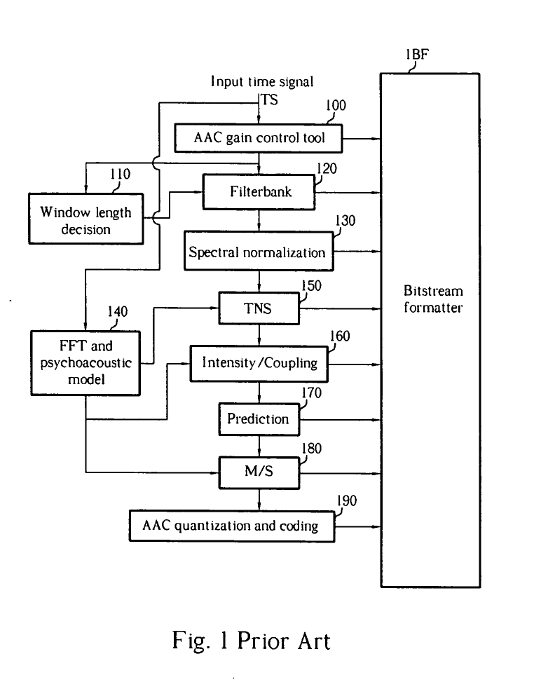

### DETAILED DESCRIPTION

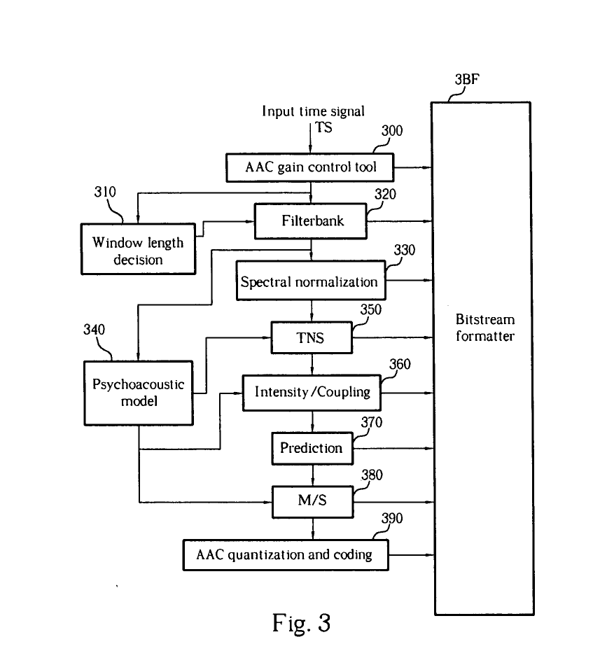

Referring to FIG. 3, is a modular chart showing an encoder using the method of the present invention. A time-domain quantized signal TS is input to an AAC Gain Control Tool 300. The gain-controlled signal is passed to a Window Length Decision 310 module as well as to the Filterbank 320. In the Window Length Decision 310 module, the signal is analyzed for tonal attack, global energy ratio, and zero-crossing ratio, and an appropriate windowing strategy is passed to the Filterbank 320. The Filterbank 320 takes the windowing strategy and the gain-controlled signal, convolves the signal into a frequency-domain data set using a Modified Discrete Cosine Transform (MDCT), and passes the frequency-domain data set to both the Psychoacoustic Model 340 and the Spectral Normalization 330 module. The Psychoacoustic Model 340 calculates masking effects and builds a set of signal-to-masking ratios. These are passed to the TNS 350 module, the Intensity/Coupling 360 module, and the M/S 380 module. The Intensity/Coupling 360 module's processing is omitted for brevity; it passes its output to the M/S 380 module, which performs a computation (omitted for brevity) and passes its output to the AAC Quantization and Coding 390 module.

The AAC Gain Control Tool 300, Filterbank 320, Spectral Normalization 330, TNS 350, Intensity/Coupling 360, Prediction 370, M/S 380, and AAC Quantization and Coding 390 modules all pass data to the Bitstream Formatter 3BF, which produces the final output.

The Psychoacoustic Model 340 requires both phase and intensity data to function. The MDCT produces only intensity data; the MDCT takes as input the time-domain series of amplitudes representing the input signal, convolves the input data, and outputs a set of real numbers representing the frequency-domain amplitudes of the signal, one number per spectral line. Unlike the FFT of the prior art, no phase data is calculated. However, by using a spectral flatness measure (SFM) to calculate a replacement for the phase data, the Psychoacoustic Model 340 can use the SFM data in combination with the MDCT's output intensity data to calculate masking.

In contrast to the prior art, the first four steps are modified as follows:
Step 1N: Input the sample stream of MDCT data. Two window lengths are used, a long window of 2048 samples and a short window of 128 samples.
Step 2N: no calculation needs to be performed here; use the complex signal from the MDCT as r(w).
Step 3N: no calculation needs to be performed here.
Step 4N: Calculate the spectral flatness measure SFM by the equation:

$${flatness}_{b} = \frac{{GM}_{b}}{{AM}_{b}} , \\ {GM}_{b} = {\prod }_{i = 0}^{N - 1} {x}_{i}^{\frac{1}{N}} , \\ {AM}_{b} = \frac{1}{N} {\sum }_{i = 0}^{N - 1} {x}_{i} \qquad ( eq 26 )$$

with the constraint that 0≦flatness_{b}<1.

Set c(w)=flatness_{b} for all w.

The remainder of the steps, Step 5 through Step 14, can proceed exactly as in the prior art. As can readily be seen, this eliminates the FFT and UM calculations, which require large amounts of processor time or expensive hardware, depending on whether the method is implemented in software or hardware.=

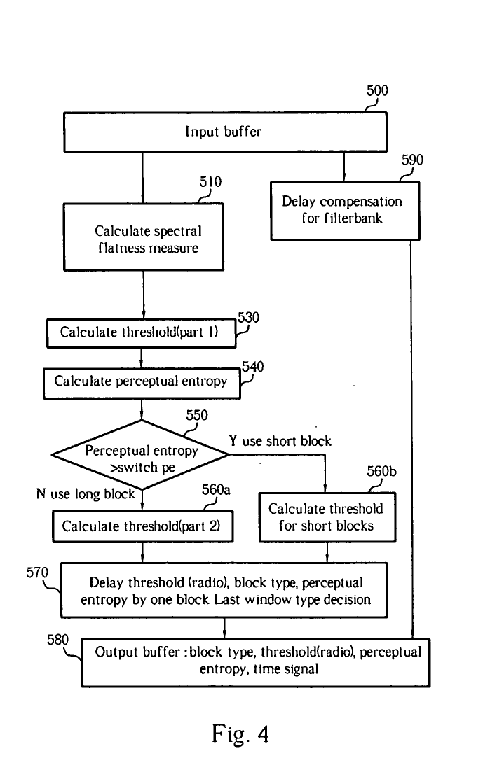

Referring to FIG. 4, a flowchart of the above method. The MDCT data of step 1N is input at block 500. (Steps 2N and 3N are no-ops and are merely mentioned to keep the sequence the same and to explain the use of the MDCT data.) The SFM calculation of step 4N is performed in block 510.

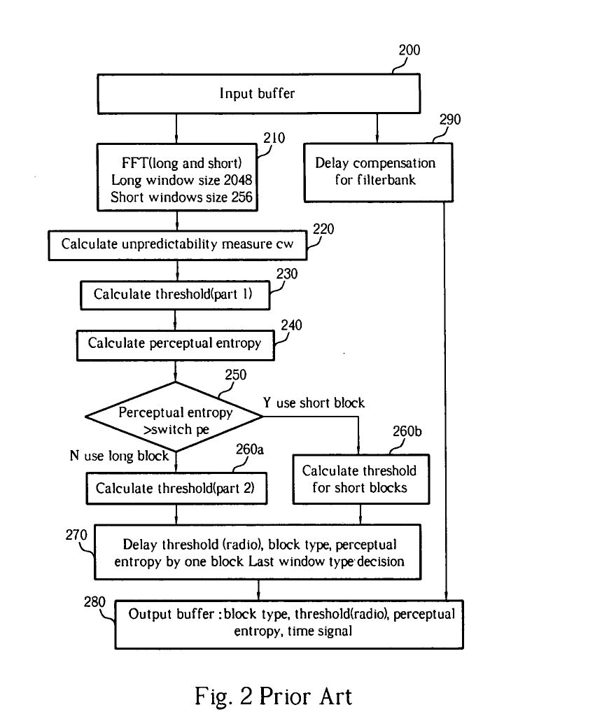

Note that the remaining steps are identical to those in FIG. 2, but for illustrative purposes FIG. 4 has been renumbered. The threshold calculation of step 5 is performed in block 530. The PE (perceptual entropy) calculations of steps 6 through 12 are performed in block 540. Blocks 550, 560a, 560b, and 570 perform step 14; block 550 chooses whether to use the long block or short block threshold calculation of step 13, and in either case block 570 makes the final window decision choice and calculates the SMRs of step 14. Block 580 lists the outputs of the calculation.

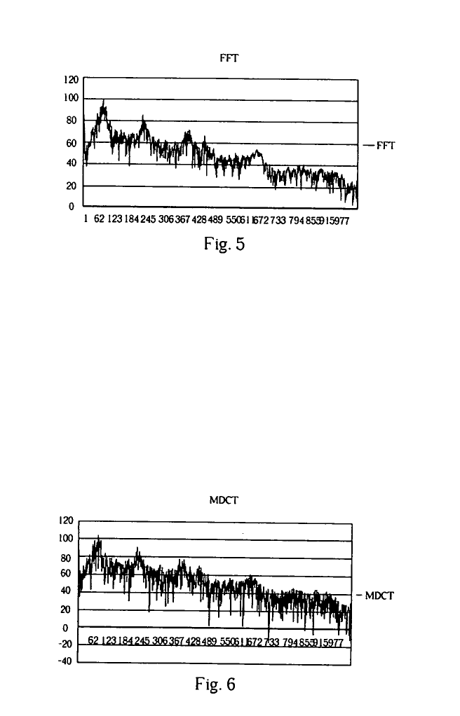

Referring to FIG. 5 and FIG. 6. FIG. 5 illustrates the output of a typical FFT calculation on a dataset. FIG. 6 illustrates the output of a MDCT calculation on the same dataset. The two spectra are quite similar.

Additional quality improvement can be had by using an improved smoothing method when calculating the energy floor to generate the SMR ratios.

$${\hat{x}}_{i} = \frac{1}{Smooth\_Length} \times {\sum }_{k = i - Smooth\_Length / 2}^{i + Smooth\_Length / 2 - 1} {x}_{k} \qquad ( eq 27 )$$

where Smooth_Length means the length of the smoothing process and xᵢ means the iₜₕ spectral line. And then

$${Energyfloor}_{b} = \frac{1}{{Bandwidth}_{b}} \times {\sum }_{for each partition band} {\hat{x}}_{i} \qquad ( eq 28 )$$

As a result of the smoothing, each spectral line will be smooth relative to neighbor lines. For example, a peak located in noise after the process of smoothing will be lower such that the attendant average represents the energy floor more meaningfully.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for encoding audio data comprising following steps:
(a) a filterbank using an modified discrete cosine transformation (MDCT) to create an MDCT dataset;
(b) a perceptual model using a spectral flatness measure to compute an uncertainty measure; and
(c) the perceptual model using the uncertainty measure and MDCT dataset to generate a set of signal-to-masking ratios.

2. A method for encoding a discretely represented time-domain signal, said signal represented by a series of integer coefficients, comprising following steps:
(a) selecting a subset of the series of coefficients according to a windowing method;
(b) transforming the subset into a frequency-domain data set of coefficients at a plurality of spectral lines using a modified discrete cosine transformation (MDCT);
(c) using the frequency-domain data set to generate a set of signal-to-masking ratios, a set of delayed time-domain data, and a set of bit-allocation limits; and
(d) generating a set of values from the set of signal-to-masking ratios, the set of bit-allocation limits, and the frequency-domain data set.

3. The method of claim 2 wherein step (c) comprises:
dividing the frequency-domain data set according to a plurality of critical bands; and
for each band, generating a ratio of a geometric mean of the coefficients at a plurality of spectral lines to an arithmetic mean of the coefficients at the plurality of spectral lines.

4. The method of claim 2 wherein step (c) comprises:
determining a first endpoint and a second endpoint of a critical band;
generating a band sum by summing smoothing values of the coefficients at a plurality of spectral lines between the first endpoint and the second endpoint of the critical band; and
calculating an energy floor by dividing the band sum by a bandwidth of the critical band.

5. The method of claim 4 further comprising:
selecting a smoothing length value which is evenly divisible by two;
calculating a first value by dividing the smoothing length value by two;
calculating a first index value by subtracting the first value from an index of a spectral line;
calculating a second index value by adding the smoothing length value minus one to the first index value;
calculating a sum of coefficients at a plurality of spectral lines with an index between the first index value to the second index value inclusive; and
dividing the sum by the smoothing length value to generate the smoothing value.

6. The method of claim 2 where the windowing method is a Kaiser-Bessel derived window.

7. The method of claim 2 where the windowing method is a sine window.

8. A method for encoding a discretely represented time-domain signal, said signal represented by a series of coefficients, comprising the following steps:
(a) selecting a subset of the series of coefficients according to a windowing method;
(b) transforming the subset into a frequency-domain data set of coefficients at a plurality of spectral lines using a modified discrete cosine transform (MDCT);
(c) dividing the frequency-domain data set according to a plurality of critical bands; and
(d) for each critical band:
(1) determining a first endpoint and a second endpoint of a critical band;
(2) generating a band sum by summing smoothing values of the coefficients at a plurality of spectral lines between the first endpoint and the second endpoint of the critical band; and
(3) calculating an energy floor for the critical band by dividing the band sum by a bandwidth of the critical band.

9. The method of claim 8 further comprising:
selecting a smoothing length value which is evenly divisible by two;
calculating a first value by dividing the smoothing length value by two;
calculating a first index value by subtracting the first value from an index of a spectral line;
calculating a second index value by adding the smoothing length value minus one to the first index value;
calculating a sum of coefficients at a plurality of spectral lines with an index between the first index value to the second index value inclusive; and
dividing the sum by the smoothing length value to generate the smoothing value.

10. A device using the method of claim 2.

11. The device of claim 10 being an MP3 recorder.

12. The device of claim 10 being an AAC recorder.
